(19) United States
(12) Patent Application Publication
(10) Pub. No.: US 2015/0139487 A1
(43) Pub. Date: May 21, 2015

(54) IMAGE PROCESSOR WITH STATIC POSE RECOGNITION MODULE UTILIZING SEGMENTED REGION OF INTEREST

(71) Applicant: LSI Corporation, San Jose, CA (US)

(72) Inventors: Pavel A. Aliseychik, Moscow (RU); Denis V. Zaytsev, Moscow (RU); Denis V. Parfenov, Moscow (RU); Dmitry N. Babin, Moscow (RU); Aleksey A. Letunovskiy, Moscow (RU)

(21) Appl. No.: 14/360,760

(22) PCT Filed: May 22, 2014
(86) PCT No.: PCT/US14/39161

§ 371 Date: May 27, 2014

(30) Foreign Application Priority Data
Nov. 21, 2013 (RU) 2013151974

(51) Int. Cl. G06K 9/00; G06F 3/01; G06T 7/00

(52) U.S. Cl. CPC G06K 9/00389; G06T 7/0081; G06T 7/0091; G06K 9/00355; G06F 3/017; G06T 2207/20044; G06T 2207/30196
USPC 382/103

(57) ABSTRACT

An image processing system comprises an image processor having image processing circuitry and an associated memory. The image processor is configured to implement a gesture recognition system comprising a static pose recognition module. The static pose recognition module is configured to identify a region of interest in at least one image, to represent the region of interest as a segmented region of interest comprising a union of segment sets from respective ones of a plurality of lines, to estimate features of the segmented region of interest, and to recognize a static pose of the segmented region of interest based on the estimated features. The lines from which the respective segment sets are taken illustratively comprise respective parallel lines configured as one of horizontal lines, vertical lines and rotated lines. A given one of the segments in one of the sets may be represented by a pair of segment coordinates.

### FIELD

The field relates generally to image processing, and more particularly to image processing for recognition of gestures.

### BACKGROUND

Image processing is important in a wide variety of different applications, and such processing may involve two-dimensional (2D) images, three-dimensional (3D) images, or combinations of multiple images of different types. For example, a 3D image of a spatial scene may be generated in an image processor using triangulation based on multiple 2D images captured by respective cameras arranged such that each camera has a different view of the scene. Alternatively, a 3D image can be generated directly using a depth imager such as a structured light (SL) camera or a time of flight (ToF) camera. These and other 3D images, which are also referred to herein as depth images, are commonly utilized in machine vision applications, including those involving gesture recognition.

In a typical gesture recognition arrangement, raw image data from an image sensor is usually subject to various preprocessing operations. The preprocessed image data is then subject to additional processing used to recognize gestures in the context of particular gesture recognition applications. Such applications may be implemented, for example, in video gaming systems, kiosks or other systems providing a gesture-based user interface. These other systems include various electronic consumer devices such as laptop computers, tablet computers, desktop computers, mobile phones and television sets.

### SUMMARY

In one embodiment, an image processing system comprises an image processor having image processing circuitry and an associated memory. The image processor is configured to implement a gesture recognition system comprising a static pose recognition module. The static pose recognition module is configured to identify a region of interest in at least one image, to represent the region of interest as a segmented region of interest comprising a union of segment sets from respective ones of a plurality of lines, to estimate features of the segmented region of interest, and to recognize a static pose of the segmented region of interest based on the estimated features.

By way of example only, the lines from which the respective segment sets are taken illustratively comprise respective parallel lines configured as one of horizontal lines, vertical lines and rotated lines. A given one of the segments in one of the sets corresponding to a particular one of the lines may be represented by a pair of segment coordinates comprising a begin coordinate and an end coordinate.

Other embodiments of the invention include but are not limited to methods, apparatus, systems, processing devices, integrated circuits, and computer-readable storage media having computer program code embodied therein.

### BRIEF DESCRIPTION OF THE DRAWINGS

FIG. 1 is a block diagram of an image processing system comprising an image processor implementing a static pose recognition module in an illustrative embodiment.

FIG. 2 is a flow diagram of an exemplary static pose recognition process performed by the static pose recognition module in the image processor of FIG. 1.

FIG. 3 shows an example of a binary mask comprising a hand region of interest and first and second segments of a segment set for a given horizontal line.

FIG. 4 is a flow diagram showing a more detailed view of a process for identifying connectivity components in a segmented region of interest in conjunction with one or more of the steps of the FIG. 2 process.

### DETAILED DESCRIPTION

Embodiments of the invention will be illustrated herein in conjunction with exemplary image processing systems that include image processors or other types of processing devices configured to perform gesture recognition. It should be understood, however, that embodiments of the invention are more generally applicable to any image processing system or associated device or technique that involves recognizing static poses in one or more images.

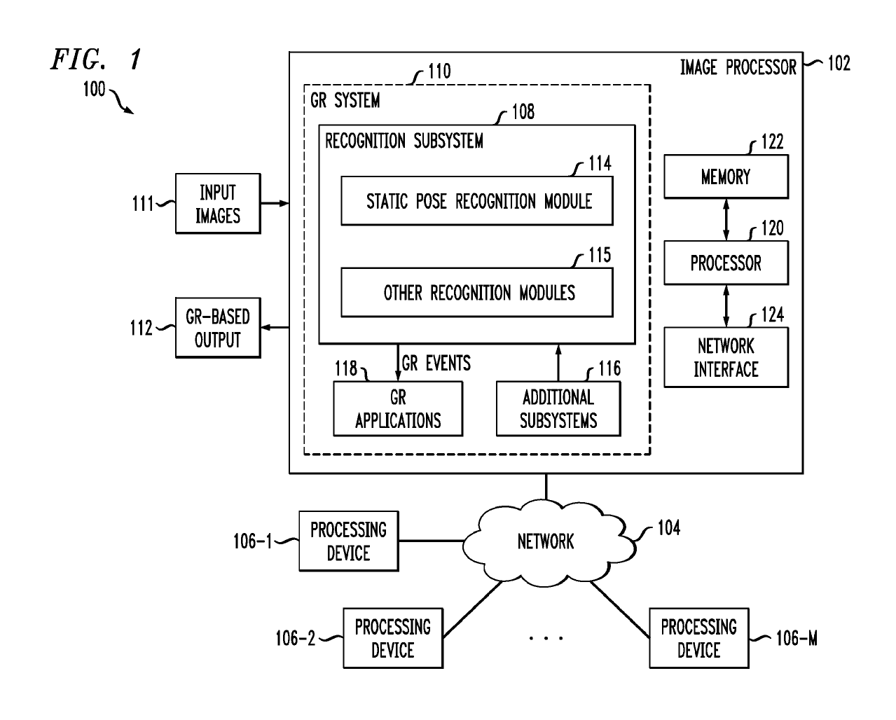

FIG. 1 shows an image processing system 100 in an embodiment of the invention. The image processing system 100 comprises an image processor 102 that is configured for communication over a network 104 with a plurality of processing devices 106-1, 106-2, . . . 106-M. The image processor 102 implements a recognition subsystem 108 within a gesture recognition (GR) system 110. The GR system 110 in this embodiment processes input images 111 from one or more image sources and provides corresponding GR-based output 112. The GR-based output 112 may be supplied to one or more of the processing devices 106 or to other system components not specifically illustrated in this diagram.

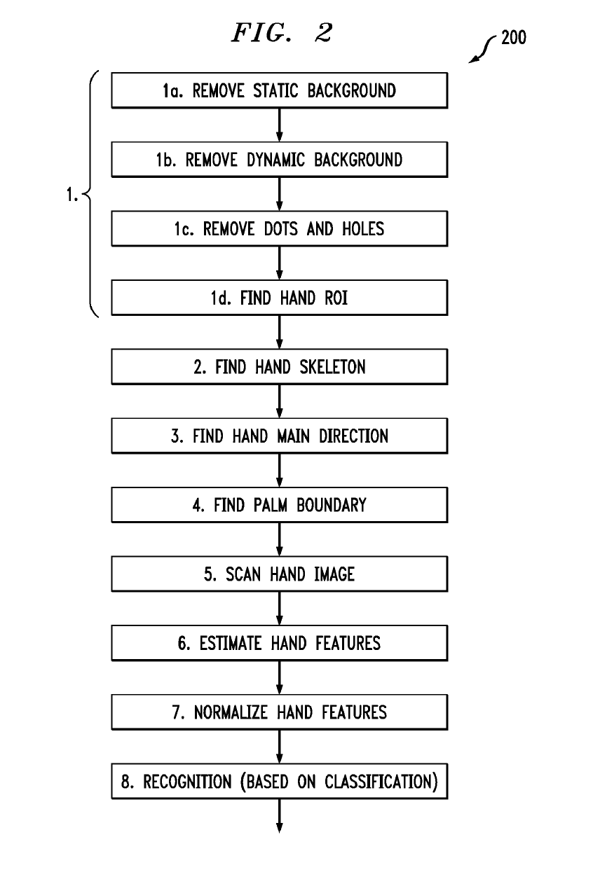

The recognition subsystem 108 of GR system 110 more particularly comprises a static pose recognition module 114 and one or more other recognition modules 115. The other recognition modules may comprise, for example, respective recognition modules configured to recognize cursor gestures and dynamic gestures. The operation of illustrative embodiments of the GR system 110 of image processor 102 will be described in greater detail below in conjunction with FIGS. 2 through 4.

The recognition subsystem 108 receives inputs from additional subsystems 116, which may comprise one or more image processing subsystems configured to implement functional blocks associated with gesture recognition in the GR system 110, such as, for example, functional blocks for input frame acquisition, noise reduction, background estimation and removal, or other types of preprocessing. In some embodiments, the background estimation and removal block is implemented as a separate subsystem that is applied to an input image after a preprocessing block is applied to the image.

Exemplary noise reduction techniques suitable for use in the GR system 110 are described in PCT International Application PCT/US13/56937, filed on Aug. 28, 2013 and entitled “Image Processor With Edge-Preserving Noise Suppression Functionality,” which is commonly assigned herewith and incorporated by reference herein.

Exemplary background estimation and removal techniques suitable for use in the GR system 110 are described in Russian Patent Application No. 2013135506, filed Jul. 29, 2013 and entitled “Image Processor Configured for Efficient Estimation and Elimination of Background Information in Images,” which is commonly assigned herewith and incorporated by reference herein.

It should be understood, however, that these particular functional blocks are exemplary only, and other embodiments of the invention can be configured using other arrangements of additional or alternative functional blocks.

In the FIG. 1 embodiment, the recognition subsystem 108 generates GR events for consumption by one or more of a set of GR applications 118. For example, the GR events may comprise information indicative of recognition of one or more particular gestures within one or more frames of the input images 111, such that a given GR application in the set of GR applications 118 can translate that information into a particular command or set of commands to be executed by that application. Accordingly, the recognition subsystem 108 recognizes within the image a gesture from a specified gesture vocabulary and generates a corresponding gesture pattern identifier (ID) and possibly additional related parameters for delivery to one or more of the applications 118. The configuration of such information is adapted in accordance with the specific needs of the application.

Additionally or alternatively, the GR system 110 may provide GR events or other information, possibly generated by one or more of the GR applications 118, as GR-based output 112. Such output may be provided to one or more of the processing devices 106. In other embodiments, at least a portion of the set of GR applications 118 is implemented at least in part on one or more of the processing devices 106.

Portions of the GR system 110 may be implemented using separate processing layers of the image processor 102. These processing layers comprise at least a portion of what is more generally referred to herein as “image processing circuitry” of the image processor 102. For example, the image processor 102 may comprise a preprocessing layer implementing a preprocessing module and a plurality of higher processing layers for performing other functions associated with recognition of gestures within frames of an input image stream comprising the input images 111. Such processing layers may also be implemented in the form of respective subsystems of the GR system 110.

It should be noted, however, that embodiments of the invention are not limited to recognition of static or dynamic hand gestures, but can instead be adapted for use in a wide variety of other machine vision applications involving gesture recognition, and may comprise different numbers, types and arrangements of modules, subsystems, processing layers and associated functional blocks. Furthermore, the segmented ROI techniques disclosed herein are not limited to use in gesture recognition, but are more generally applicable in numerous other contexts, including facial recognition, full body recognition, object detection and tracking, and other image processing applications.

Also, certain processing operations associated with the image processor 102 in the present embodiment may instead be implemented at least in part on other devices in other embodiments. For example, preprocessing operations may be implemented at least in part in an image source comprising a depth imager or other type of imager that provides at least a portion of the input images 111. It is also possible that one or more of the applications 118 may be implemented on a different processing device than the subsystems 108 and 116, such as one of the processing devices 106.

Moreover, it is to be appreciated that the image processor 102 may itself comprise multiple distinct processing devices, such that different portions of the GR system 110 are implemented using two or more processing devices. The term “image processor” as used herein is intended to be broadly construed so as to encompass these and other arrangements.

The GR system 110 performs preprocessing operations on received input images 111 from one or more image sources. This received image data in the present embodiment is assumed to comprise raw image data received from a depth sensor, but other types of received image data may be processed in other embodiments. Such preprocessing operations in the present embodiment are assumed to include at least noise reduction, but in other embodiments can include additional operations such as background estimation and removal.

The raw image data received by the GR system 110 from the depth sensor illustratively includes a stream of frames comprising respective depth images, with each such depth image comprising a plurality of depth image pixels. For example, a given depth image D may be provided to the GR system 110 in the form of a matrix of real values. A given such depth image is also referred to herein as a depth map.

A wide variety of other types of images or combinations of multiple images may be used in other embodiments. It should therefore be understood that the term “image” as used herein is intended to be broadly construed.

The image processor 102 may interface with a variety of different image sources and image destinations. For example, the image processor 102 may receive input images 111 from one or more image sources and provide processed images as part of GR-based output 112 to one or more image destinations. At least a subset of such image sources and image destinations may be implemented as least in part utilizing one or more of the processing devices 106.

Accordingly, at least a subset of the input images 111 may be provided to the image processor 102 over network 104 for processing from one or more of the processing devices 106. Similarly, processed images or other related GR-based output 112 may be delivered by the image processor 102 over network 104 to one or more of the processing devices 106. Such processing devices may therefore be viewed as examples of image sources or image destinations as those terms are used herein.

A given image source may comprise, for example, a 3D imager such as an SL camera or a ToF camera configured to generate depth images, or a 2D imager configured to generate grayscale images, color images, infrared images or other types of 2D images. It is also possible that a single imager or other image source can provide both a depth image and a corresponding 2D image such as a grayscale image, a color image or an infrared image. For example, certain types of existing 3D cameras are able to produce a depth map of a given scene as well as a 2D image of the same scene. Alternatively, a 3D imager providing a depth map of a given scene can be arranged in proximity to a separate high-resolution video camera or other 2D imager providing a 2D image of substantially the same scene.

Another example of an image source is a storage device or server that provides images to the image processor 102 for processing.

A given image destination may comprise, for example, one or more display screens of a human-machine interface of a computer or mobile phone, or at least one storage device or server that receives processed images from the image processor 102.

It should also be noted that the image processor 102 may be at least partially combined with at least a subset of the one or more image sources and the one or more image destinations on a common processing device. Thus, for example, a given image source and the image processor 102 may be collectively implemented on the same processing device. Similarly, a given image destination and the image processor 102 may be collectively implemented on the same processing device.

In the present embodiment, the image processor 102 is configured to recognize hand gestures, although the disclosed techniques can be adapted in a straightforward manner for use with other types of gesture recognition processes.

As noted above, the input images 111 may comprise respective depth images generated by a depth imager such as an SL camera or a ToF camera. Other types and arrangements of images may be received, processed and generated in other embodiments, including 2D images or combinations of 2D and 3D images.

The particular arrangement of subsystems, applications and other components shown in image processor 102 in the FIG. 1 embodiment can be varied in other embodiments. For example, an otherwise conventional image processing integrated circuit or other type of image processing circuitry suitably modified to perform processing operations as disclosed herein may be used to implement at least a portion of one or more of the components 114, 115, 116 and 118 of image processor 102. One possible example of image processing circuitry that may be used in one or more embodiments of the invention is an otherwise conventional graphics processor suitably reconfigured to perform functionality associated with one or more of the components 114, 115, 116 and 118.

The processing devices 106 may comprise, for example, computers, mobile phones, servers or storage devices, in any combination. One or more such devices also may include, for example, display screens or other user interfaces that are utilized to present images generated by the image processor 102. The processing devices 106 may therefore comprise a wide variety of different destination devices that receive processed image streams or other types of GR-based output 112 from the image processor 102 over the network 104, including by way of example at least one server or storage device that receives one or more processed image streams from the image processor 102.

Although shown as being separate from the processing devices 106 in the present embodiment, the image processor 102 may be at least partially combined with one or more of the processing devices 106. Thus, for example, the image processor 102 may be implemented at least in part using a given one of the processing devices 106. As a more particular example, a computer or mobile phone may be configured to incorporate the image processor 102 and possibly a given image source. Image sources utilized to provide input images 111 in the image processing system 100 may therefore comprise cameras or other imagers associated with a computer, mobile phone or other processing device. As indicated previously, the image processor 102 may be at least partially combined with one or more image sources or image destinations on a common processing device.

The image processor 102 in the present embodiment is assumed to be implemented using at least one processing device and comprises a processor 120 coupled to a memory 122. The processor 120 executes software code stored in the memory 122 in order to control the performance of image processing operations. The image processor 102 also comprises a network interface 124 that supports communication over network 104. The network interface 124 may comprise one or more conventional transceivers. In other embodiments, the image processor 102 need not be configured for communication with other devices over a network, and in such embodiments the network interface 124 may be eliminated.

The processor 120 may comprise, for example, a microprocessor, an application-specific integrated circuit (ASIC), a field-programmable gate array (FPGA), a central processing unit (CPU), an arithmetic logic unit (ALU), a digital signal processor (DSP), or other similar processing device component, as well as other types and arrangements of image processing circuitry, in any combination.

The memory 122 stores software code for execution by the processor 120 in implementing portions of the functionality of image processor 102, such as the subsystems 108 and 116 and the GR applications 118. A given such memory that stores software code for execution by a corresponding processor is an example of what is more generally referred to herein as a computer-readable medium or other type of computer program product having computer program code embodied therein, and may comprise, for example, electronic memory such as random access memory (RAM) or read-only memory (ROM), magnetic memory, optical memory, or other types of storage devices in any combination. As indicated above, the processor may comprise portions or combinations of a microprocessor, ASIC, FPGA, CPU, ALU, DSP or other image processing circuitry.

It should also be appreciated that embodiments of the invention may be implemented in the form of integrated circuits. In a given such integrated circuit implementation, identical die are typically formed in a repeated pattern on a surface of a semiconductor wafer. Each die includes an image processor or other image processing circuitry as described herein, and may include other structures or circuits. The individual die are cut or diced from the wafer, then packaged as an integrated circuit. One skilled in the art would know how to dice wafers and package die to produce integrated circuits. Integrated circuits so manufactured are considered embodiments of the invention.

The particular configuration of image processing system 100 as shown in FIG. 1 is exemplary only, and the system 100 in other embodiments may include other elements in addition to or in place of those specifically shown, including one or more elements of a type commonly found in a conventional implementation of such a system.

For example, in some embodiments, the image processing system 100 is implemented as a video gaming system or other type of gesture-based system that processes image streams in order to recognize user gestures. The disclosed techniques can be similarly adapted for use in a wide variety of other systems requiring a gesture-based human-machine interface, and can also be applied to other applications, such as machine vision systems in robotics and other industrial applications that utilize gesture recognition.

Also, as indicated above, embodiments of the invention are not limited to use in recognition of hand gestures, but can be applied to other types of gestures as well. The term “gesture” as used herein is therefore intended to be broadly construed.

The operation of the GR system 110 of image processor 102 will now be described in greater detail with reference to the diagrams of FIGS. 2 through 4.

It is assumed in these embodiments that the input images 111 received in the image processor 102 from an image source comprise input depth images each referred to as an input frame. As indicated above, this source may comprise a depth imager such as an SL or ToF camera comprising a depth image sensor. Other types of image sensors including, for example, grayscale image sensors, color image sensors or infrared image sensors, may be used in other embodiments. A given image sensor typically provides image data in the form of one or more rectangular matrices of real or integer numbers corresponding to respective input image pixels. These matrices can contain per-pixel information such as depth values and corresponding amplitude or intensity values. Other per-pixel information such as color, phase and validity may additionally or alternatively be provided.

Referring now to FIG. 2, a process 200 performed by the static pose recognition module 114 in an illustrative embodiment is shown. The process is assumed to be applied to preprocessed image frames received from a preprocessing subsystem of the set of additional subsystems 116. As indicated above, the preprocessing subsystem is assumed to perform noise reduction, although additional or alternative preprocessing operations can be used. The image frames are received by the preprocessing subsystem as raw image data from an image sensor of a depth imager such as a ToF camera or other type of ToF imager.

The image sensor in this embodiment is assumed to comprise a variable frame rate image sensor, such as a ToF image sensor configured to operate at a variable frame rate. Accordingly, in the present embodiment, the static pose recognition module 114 can operate at a lower frame rate than other recognition modules 115, such as recognition modules configured to recognize cursor gestures and dynamic gestures. Other types of sources supporting variable or fixed frame rates can be used in other embodiments. Also, the modules 114 and 115 in other embodiments can be configured such that all such modules operate at the same frame rate.

The process 200 includes the following steps:

1a. Remove static background;

1b. Remove dynamic background;

1c. Remove dots and holes;

1d. Find hand region of interest (ROI);

2. Find hand skeleton;

3. Find hand main direction;

4. Find palm boundary;

5. Scan hand image;

6. Estimate hand features;

7. Normalize hand features; and

8. Recognition based on classification.

The steps of the process 200 will be described in greater detail below. In other embodiments, certain steps may be combined with one another, or additional or alternative steps may be used. For example, Step 4 could be removed in some embodiments, or the sequence of steps could be altered.

Step 1 is separated into four distinct steps in the process 200 in order to emphasize that the ordering of these steps is subject to variation in different embodiments. For example, in some embodiments herein, steps 1b and 1c are performed using a segmented ROI, and are therefore performed subsequent to determination of the ROI in step 1d. It should therefore be appreciated that the particular ordering of these and other steps as shown in FIG. 2 is by way of illustrative example only.

As a more particular example of one possible implementation of the FIG. 2 process, the process may start with static background removal in Step 1a, followed by an implementation of Step 1d that includes substeps of finding a binary ROI mask and representing the binary ROI mask as a segmented ROI, followed by dynamic background removal in Step 1b and dots and holes removal in Step 1c. In an arrangement of this type, the ROI determination is performed at least in part prior to the dynamic background removal and dots and holes removal. Other arrangements are possible. For example, the segmented ROI can instead be generated at Step 5 and utilized in at least Steps 6 and 7. Such an arrangement is an example of an arrangement in the segmented ROI is generated in conjunction with a scanning operation.

Accordingly, it is assumed for further description below that at least portions of the process 200 are performed utilizing a segmented ROI. More particularly, in some embodiments, the portions of the process 200 that are performed utilizing the segmented ROI include at least dynamic background removal in Step 1b, dots and holes removal in Step 1c and hand feature estimation in Step 6. At least portions of other process steps associated with the hand feature estimation of Step 6, such as Steps 4, 5, 7 and 8, may additionally be performed using the segmented ROI.

Typically, the segmented ROI is used for those portions of the static pose recognition process that would be most time consuming to perform using the binary ROI mask. Thus, use of the segmented ROI in place of the binary ROI mask for those portions of the process can significantly accelerate the performance of the overall process.

Other portions of the process 200 may be performed utilizing the binary ROI mask. These portions may include, for example, Steps 2 and 3.

It is therefore to be appreciated that some embodiments will perform the process 200 primarily using the segmented ROI, while other embodiments will perform certain portions of the process 200 utilizing the binary ROI mask and other portions of the process 200 utilizing the segmented ROI. The particular portions of the process that are performed utilizing the segmented ROI can therefore vary from embodiment to embodiment.

Additional details regarding exemplary implementations of Steps 2 through 8 utilizing a binary ROI mask can be found in Russian Patent Application Attorney Docket No. L13-0959US1, filed Oct. 30, 2013 and entitled “Image Processor Comprising Gesture Recognition System with Computationally-Efficient Static Hand Pose Recognition,” which is commonly assigned herewith and incorporated by reference herein.

The segmented ROI comprises a union of segment sets from respective ones of a plurality of lines. A given one of the segments in one of the sets corresponding to a particular one of the lines is represented by a pair of segment coordinates comprising a begin coordinate and an end coordinate. The segment coordinates are illustratively integer values corresponding to particular row or column numbers of an image. The plurality of lines from which the respective segment sets are taken comprise respective parallel lines configured as one of horizontal lines, vertical lines and rotated lines. Other types of segmentation arrangements may be used to construct the segmented ROI in other embodiments. For example, the segment coordinates may be represented using floating point values, which will generally provide higher precision than integer values but may require additional processing time.

The use of a segmented ROI in place of a binary ROI mask allows for increased computationally efficiency as well as reduced storage requirements for various ROI-based operations performed by the static pose recognition module 114, leading to improved overall performance in the recognition subsystem 108 and GR system 110.

Prior to generating the segmented ROI, an ROI mask is defined for a hand in the image. The ROI mask is implemented as a binary mask in the form of an image, also referred to herein as a “hand image,” in which pixels within the ROI have a certain binary value, illustratively a logic 1 value, and pixels outside the ROI have the complementary binary value, illustratively a logic 0 value. The ROI in the present embodiment illustratively corresponds to a hand within the input image, and is therefore also referred to herein as a hand ROI. In other embodiments, the ROI may correspond to another type of object of interest, such as a complete body in a long-range GR application, or a head or face in a facial recognition application.

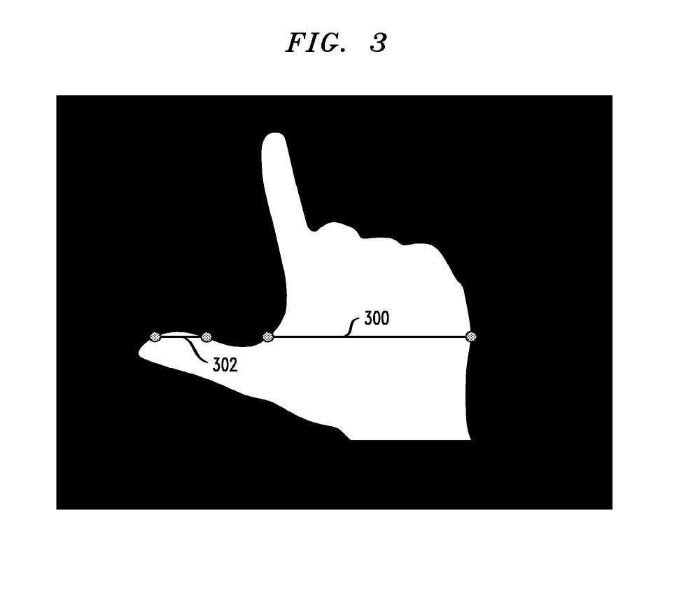

An example of a binary ROI mask comprising a hand ROI can be seen in FIG. 3. The ROI mask in this figure is shown with 1-valued or “white” pixels identifying those pixels within the ROI, and 0-valued or “black” pixels identifying those pixels outside of the ROI. It can be seen that the hand ROI in the example of FIG. 3 is in the form of a particular type of static hand pose, namely, a “fingergun” static hand pose. This is one of multiple static hand poses that may be recognized using the process 200.

The hand ROI can be identified in the preprocessed image using any of a variety of techniques. For example, it is possible to utilize the techniques disclosed in the above-cited Russian Patent Application No. 2013135506 to determine the hand ROI. Accordingly, the generation of a binary ROI mask for use in conjunction with performance of the process 200 may be implemented in a preprocessing block of the GR system 110 rather than in the static pose recognition module 114.

As another example, the hand ROI can be determined using threshold logic applied to depth and amplitude values of the image. This can be more particularly implemented as follows:

1. If the amplitude values are known for respective pixels of the image, one can select only those pixels with amplitude values greater than some predefined threshold. This approach is applicable not only for images from ToF imagers, but also for images from other types of imagers, such as infrared imagers with active lighting. For both ToF imagers and infrared imagers with active lighting, the closer an object is to the imager, the higher the amplitude values of the corresponding image pixels, not taking into account reflecting materials. Accordingly, selecting only pixels with relatively high amplitude values allows one to preserve close objects from an imaged scene and to eliminate far objects from the imaged scene. It should be noted that for ToF imagers, pixels with lower amplitude values tend to have higher error in their corresponding depth values, and so removing pixels with low amplitude values additionally protects one from using incorrect depth information.

2. If the depth values are known for respective pixels of the image, one can select only those pixels with depth values falling between predefined minimum and maximum threshold depths Dmin and Dmax. These thresholds are set to appropriate distances between which the hand is expected to be located within the image.

3. Opening or closing morphological operations utilizing erosion and dilation operators can be applied to remove dots and holes as well as other spatial noise in the image.

One possible implementation of a threshold-based ROI determination technique using both amplitude and depth thresholds is as follows:

1. Set ROIij=0 for each i and j.

2. For each depth pixel dᵢⱼ set ROIᵢⱼ=1 if dᵢⱼ≧dₘᵢₙ and dᵢⱼ≦dₘₐₓ.

3. For each amplitude pixel aᵢⱼ set ROIᵢⱼ=1 if aᵢⱼ≧aₘᵢₙ.

4. Coherently apply an opening morphological operation comprising erosion followed by dilation to both ROI and its complement to remove dots and holes comprising connected regions of ones and zeros having area less than a minimum threshold area Aₘᵢₙ.

It should be noted that the morphological operations above can alternatively be applied to a segmented ROI, in order to improve computational efficiency, as will be described in more detail elsewhere herein.

In embodiments in which morphological operations are applied to the segmented ROI, or in which alternative techniques are used for removal of dots and holes from the segmented ROI, the above morphological operations can be eliminated.

The output of the above-described ROI determination process is a binary ROI mask for the hand in the image. It can be in the form of an image having the same size as the input image, or a sub-image containing only those pixels that are part of the ROI. For further description below, it is assumed that the ROI mask is an image having the same size as the input image. As mentioned previously, the ROI mask is also referred to herein as a “hand image” and the ROI itself within the ROI mask is referred to as a “hand ROI.” The output may include additional information such as an average of the depth values for the pixels in the ROI.

The binary ROI mask determined in the manner described above is further processed to obtain a segmented ROI. As mentioned previously, the segmented ROI in the present embodiment comprises a union of segment sets from respective ones of a plurality of lines. The lines in this embodiment refer to lines in the binary ROI mask or hand image, which is assumed to have the same size as the input image. Each segment set includes one or more segments associated with the same image line, with each such segment being represented by a pair of segment coordinates comprising a begin coordinate and an end coordinate.

It is more particularly assumed for further description below that the plurality of lines from which the respective segment sets are taken comprise respective parallel horizontal lines, although other types of parallel lines can be used in other embodiments, such as vertical lines and rotated lines. Accordingly, the one or more segments of a particular segment set comprise respective one-dimensional segments that lie along a given horizontal line or row of the binary ROI mask, with each such segment being represented by a begin coordinate and an end coordinate that correspond to respective integers identifying the respective column numbers of the beginning and ending pixels of the segment.

An exemplary segment set of the type described above is shown superimposed on the hand ROI of the binary ROI mask of FIG. 3. In this embodiment, the segment set includes first and second segments 300 and 302. Each segment is defined as a plurality of contiguous 1-valued or “white” pixels in a horizontal line of the hand ROI, bounded on either end by respective 0-valued or “black” pixels of the horizontal line, where the horizontal line in this embodiment corresponds to a given row of the binary ROI mask. The first segment 300 corresponds to part of the back of the hand and the second segment 302 corresponds to part of the tip of the thumb. The segmented ROI includes other segment sets corresponding to respective other horizontal lines each comprising one or more segments within that horizontal line.

The length of a given segment s of a segment set for a particular horizontal line l is denoted L(s), and the weight of the horizontal line l is denoted W(l) and is given by the sum of the lengths L(s) of the respective segments on that line.

The segmented ROI is constructed by scanning the binary ROI mask line-by-line to determine the segment set for each line. The union of the resulting segment sets provides the segmented ROI. As noted above, use of horizontal lines corresponding to respective image rows is assumed in the present embodiment. This allows the original binary ROI mask to be reconstructed from the segmented ROI in a bit-exact way. A similar effect can be achieved using vertical lines corresponding to respective image columns. Use of rotated lines can add noise at the edges of the ROI, although techniques for addressing this issue are disclosed in the above-cited Russian Patent Application Attorney Docket No. L13-0959US1.

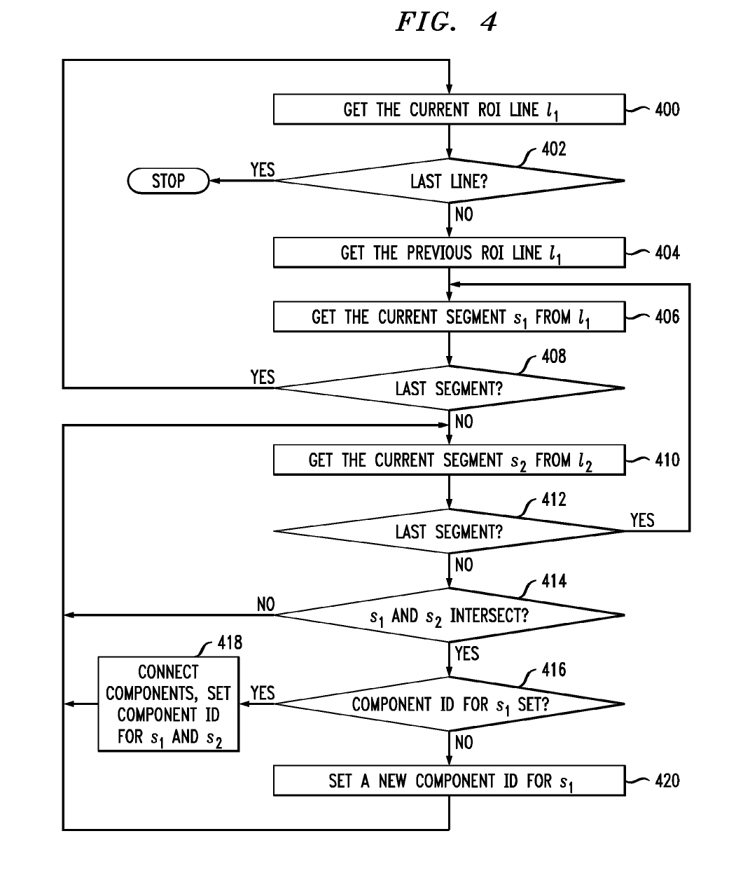

The segmented ROI can be further processed in the manner shown in FIG. 4 in order to identify connectivity components within the ROI. Such connectivity components are useful, for example, in removing dynamic background from the segmented ROI in Step 1b and in removing dots and holes from the segmented ROI in Step 1c. The FIG. 4 process includes steps 400 through 420 and is applied to lines and segments of a segmented ROI. The process determines component connectivity within the segmented ROT by connecting components using graph-based techniques. This exemplary graph-based process generally utilizes a one-dimensional intersection of two segments from two neighboring lines as a graph edge and connects these two segments as respective graph nodes.

In step 400, a current line l₁ is obtained. If the current line l₁ is determined in step 402 to be the last line, the process stops as indicated. Otherwise the previous line l₁ is obtained in step 404, and a current segment s₁ is obtained from l₁ in step 406. If the current segment s₁ is determined in step 408 to be the last segment for line l₁, the process returns to step 400 to obtain the next line. Otherwise, a current segment s₂ is obtained from l₂ in step 410. If the current segment s₂ is determined in step 412 to be the last segment for line l₂, the process returns to step 406 as indicated.

If it is determined in step 412 that the current segment s₂ is not the last segment for line l₂, a determination is made in step 414 as to whether or not the segments s₁ and s₂ intersect. In this context, “intersection” refers to an intersection of one-dimensional segments. If the segments s₁ and s₂ intersect, and if step 416 determines that a component identifier (ID) has not been previously set for segment s₁, a new component ID is set for s₁ in step 420, and the process then returns to step 410. If the segments S₁ and s₂ intersect, and if step 416 determines that a component ID has been previously set for segment s₁, the segments s₁ and s₂ are connected by setting both to a common component ID in step 418, and the process then returns to step 410. If the segments s₁ and s₂ do not intersect, the process returns directly to step 410, thereby skipping steps 416, 418 and 420.

The determination of connectivity components as illustrated in FIG. 4 is exemplary only, and other graph-based techniques can be used in other embodiments. Also, other embodiments need not utilize any connectivity component determination.

As mentioned above, the portions of the process 200 that are performed utilizing the segmented ROI include at least dynamic background removal in Step 1b, dots and holes removal in Step 1c and hand feature estimation in Step 6. Each of these portions of the process 200 will now be described in greater detail. Again, it should be understood that the following description assumes the use of horizontal lines for the segmented ROI, but other types of parallel lines can be used in other embodiments.

The removal of dynamic background in Step 1b utilizes the connectivity components determined as described previously in conjunction with FIG. 4. The dynamic background may comprise portions of a user's head or body that are not part of the static background and are therefore not removed by Step 1a. Heuristics may be used to determine which of the connectivity components are associated with dynamic background and should be removed from the segmented ROI. For example, one or more connectivity components having the lowest average depth values may be identified as comprising the segmented ROI while one or more other components having greater average depth values are removed as dynamic background. Other definitions of dynamic background based on connectivity components may be used.

The removal of dots and holes in Step 1c also utilizes the connectivity components determined as described previously in conjunction with FIG. 4. The term “dots” generally refers to relatively small parts of the image that are outside the ROI but were not removed by Steps 1a and 1b. Accordingly, dots lie outside of the ROI but nonetheless comprise groups of 1-valued pixels. The term “holes” generally refers to relatively small parts of the image that belong to the ROI but were removed by Steps 1a and 1b. Accordingly, holes lie within the ROI but nonetheless comprise groups of 0-valued pixels.

The removal of dots is illustratively implemented by removing all connectivity components of the segmented ROI that contain less than a specified threshold number of pixels.

The removal of holes is illustratively implemented by inverting the segmented ROI, removing the dots from the inverted segmented ROI in the manner described above, although possibly using a different specified threshold number of pixels, and then once again inverting the resulting segmented ROI. The inversion process for a given segmented ROI can be implemented by generating a new segmented ROI that contains all of the segments within the rectangle [0,w]×[0,h] that are not part of the given segmented ROI, where w and h denote the respective width and height of the corresponding image in pixels.

As mentioned previously, the segmented ROI may be further refined by application of one or more morphological operations, possibly subsequent to performance of Steps 1b and 1c on the segmented ROI as described above. Such operations are also referred to as “morphological filtering” and are typically applied to provide further improvements in image quality prior to hand feature estimation. For example, morphological filtering may be used to remove noise at the edges of the segmented ROI.

A given morphological operation generally comprises at least one a dilation operation, an erosion operation, an opening operation and a closing operation, where the opening and closing operations each comprise a distinct sequence of at least one dilation operation and at least one erosion operation.

The dilation operation is illustratively implemented by increasing a length of at least one segment of at least one line and adding at least one new segment to both neighboring lines. As a more particular example, a given dilation operation may comprise the following steps:

1. Dilating each single ROI segment by increasing the length of the segment and maintaining a list of new segments which have to be added to the neighboring lines.

2. Adding the new segments from the list to the neighboring lines and uniting any intersecting segments into single segments.

The erosion operation is illustratively implemented by inverting the segmented ROI, applying a dilation operation as described above to the inverted segmented ROI, and inverting the result to obtain the segmented ROI.

A wide variety of other morphological filters or more generally other morphological operations can be implemented as a sequence of dilation and erosion operations.

After the segmented ROI has been refined in the manner described above, additional steps of the process 200 of FIG. 2 are applied to the segmented ROI. As noted above, these additional steps are assumed in the present embodiment to include at least hand feature estimation in Step 6, and may include at least portions of other related steps such as Steps 4, 5, 7 and 8.

The manner in which exemplary hand features are estimated in Step 6 using the segmented ROI will now be described in more detail. These exemplary features include global width, local width for a specified line, global height, weight for a specified line, area, perimeter and first and second moments. Other hand features can be estimated from the segmented ROI in other embodiments.

The global width of the segmented ROI is estimated as a difference between a maximal segment end coordinate and a minimal segment begin coordinate over the sets of segments that make up the segmented ROI. This hand feature is also referred to as “total width” of the segmented ROI.

The local width of the segmented ROI for a specified line is estimated as a difference between an end coordinate of a final segment of that line and a begin coordinate of an initial segment of that line. This hand feature is also referred to as width of the segmented ROI at a specified height.

The global height of the segmented ROI is estimated based on pixel coordinates of first and last ones of the plurality of lines. For example, in the present embodiment based on horizontal lines corresponding to respective image rows, the global height may be estimated as a difference between y coordinates of the first and last non-empty lines of the segmented ROI. This hand feature is also referred to as “total height” of the segmented ROI.

The weight of the segmented ROI for a specified line is estimated as a sum of segment lengths for the set of segments from that line. For example, in the present embodiment based on horizontal lines corresponding to respective image rows, the weight of the segmented ROI at a specified height Y may be defined as the number of pixels which belong to the ROI and have y coordinates that are equal to Y. This estimate corresponds to weight W(l_{Y}), where l_{Y} is a horizontal line at the height Y.

The area of the segmented ROI is estimated as a sum of weights estimated for respective ones of the plurality of lines. For example, the area of the segmented ROI may be found as a sum of weights W(l) for all of the lines of the segmented ROI.

The perimeter of the segmented ROI is estimated utilizing a recursive procedure based on a weight of the segmented ROI for a specified line. For example, one possible implementation of the recursive procedure is configured to calculate a perimeter P(Y) for the portion of the segmented ROI located above a certain height Y. This exemplary perimeter includes weight W(l_{Y}) as a length of the top edge, and the corresponding recursive procedure includes the following steps:

1. Set P(−1)=0, W(−1)=0.

2. P(Y)=P(Y−1)+W(l_{Y})−W(l_{Y-1})+I(l_{Y}, l_{Y-1})−I(l_{Y-1}, l_{Y}), where I(l₁, l₂) denotes the number of pixels which belong to line l₁ and do not belong to line l₂.

The first moment for a first coordinate x of the segmented ROI is estimated as a function of segment lengths for all of the segments of the segmented ROI. For example, the first moment for x may be calculated as a sum of L(s)*(s.end−s.beg) for all of the segments of the segmented ROI, where s.end and s.beg denote respective end and begin coordinates of segment s.

The first moment for a second coordinate y of the segmented ROI is estimated as a function of segment weights for all of the segments of the segmented ROI. For example, the first moment for y may be calculated as a sum of W(y)*y for all of the segments of the segmented ROI.

The second moments for the respective first and second coordinates x and y are estimated as a function of the respective first moments for x and y. For example, the second moment for x can be calculated as a sum of M2(s)=F(s.end−meanX)−F(s.beg−meanX), where meanX denotes the first moment for x, and F(n)=1*1+2*2+ . . . +n*n=n*(n+1)*(2n+1)/6 is an efficient representation of a sum of squares, and the second moment for y may be calculated as a sum of W(l_{Y})*(Y−meanY)*(Y−meanY), where meanY is the first moment for y.

The above-noted coordinates x and y associated with the segmented ROI can differ from the original coordinates x and y of the binary mask, for example, in cases where the segmented ROI is generated using parallel lines that are not horizontal. The x coordinates of the segmented ROI are assumed to be the coordinates along the parallel lines and the y coordinates of the segmented ROI are assumed to the coordinates along perpendiculars to the parallel lines. For a segmented ROI constructed using horizontal lines corresponding to respective image rows, the x and y coordinates are assumed to be the same as those of the binary mask.

It should be noted that the above-described hand features are exemplary only, and additional or alternative hand features may be determined from a segmented ROI and utilized to facilitate static pose recognition in other embodiments. For example, various functions of one or more of the above-described hand features or other related hand features may be used as additional or alternative hand features. Also, techniques other than those described above may be used to compute the features.

The particular number of features utilized in a given embodiment will typically depend on factors such as the number of different hand pose classes to be recognized, the shape of an average hand inside each class, and the recognition quality requirements. Techniques such as Monte-Carlo simulations or genetic search algorithms can be utilized to determine an optimal subset of the features for given levels of computational complexity and recognition quality.

Some embodiments can utilize a combination of hand features estimated using the segmented ROI and other hand features estimated using the binary ROI mask. Examples of hand features of the latter type are disclosed in the above-cited Russian Patent Application Attorney Docket No. L13-0959US1. For certain types of hand features, normalization is applied in Step 7, while for other types of hand features, normalization need not be applied. Accordingly, Step 7, like one or more other steps of the exemplary static pose recognition process 200, may be eliminated in other embodiments.

In Step 8, classification techniques are applied to recognize static hand poses based on the estimated hand features from Step 6, after application of normalization, if any, in Step 7. Examples of static pose classes that may be utilized in a given embodiment include finger, palm with fingers, palm without fingers, hand edge, pinch, fist, fingergun and head. Each static pose class utilizes a corresponding classifier configured in accordance with a classification technique such as, for example, Gaussian Mixture Models (GMMs), Nearest Neighbor, Decision Trees, and Neural Networks. Additional details regarding the use of classifiers based on GMMs in the recognition of static hand poses can be found in the above-cited Russian Patent Application No. 2013134325.

The particular types and arrangements of processing blocks shown in the embodiments of FIGS. 2 and 4 are exemplary only, and additional or alternative blocks can be used in other embodiments. For example, blocks illustratively shown as being executed serially in the figures can be performed at least in part in parallel with one or more other blocks or in other pipelined configurations in other embodiments.

Illustrative embodiments can provide significantly improved gesture recognition performance relative to conventional arrangements. For example, these embodiments provide computationally-efficient static pose recognition using a segmented ROI rather than a binary ROI mask for at least portions of the recognition process, thereby allowing ROI-based operations to be performed at higher speed and with less memory than would otherwise be possible. Accordingly, the GR system performance is accelerated while ensuring high precision in the recognition process. The disclosed techniques can be applied to a wide range of different GR systems, using depth, grayscale, color infrared and other types of imagers which support a variable frame rate, as well as imagers which do not support a variable frame rate. Again, the disclosed techniques are not limited for use in gesture recognition, and can be more generally applied in numerous alternative image processing applications.

Different portions of the GR system 110 can be implemented in software, hardware, firmware or various combinations thereof. For example, software utilizing hardware accelerators may be used for some processing blocks while other blocks are implemented using combinations of hardware and firmware.

At least portions of the GR-based output 112 of GR system 110 may be further processed in the image processor 102, or supplied to another processing device 106 or image destination, as mentioned previously.

It should again be emphasized that the embodiments of the invention as described herein are intended to be illustrative only. For example, other embodiments of the invention can be implemented utilizing a wide variety of different types and arrangements of image processing circuitry, modules, processing blocks and associated operations than those utilized in the particular embodiments described herein. In addition, the particular assumptions made herein in the context of describing certain embodiments need not apply in other embodiments. These and numerous other alternative embodiments within the scope of the following claims will be readily apparent to those skilled in the art.

What is claimed is:

1. A method comprising steps of:
identifying a region of interest in at least one image;
representing the region of interest as a segmented region of interest comprising a union of segment sets from respective ones of a plurality of lines;
estimating features of the segmented region of interest; and
recognizing a static pose of the segmented region of interest based on the estimated features;
wherein the steps are implemented in an image processor comprising a processor coupled to a memory.

2. The method of claim 1 wherein the steps are implemented in a static pose recognition module of a gesture recognition system of the image processor.

3. The method of claim 1 wherein the segmented region of interest is generated in conjunction with a scanning operation.

4. The method of claim 1 wherein a given one of the segments in one of the sets corresponding to a particular one of the lines is represented by a pair of segment coordinates comprising a begin coordinate and an end coordinate.

5. The method of claim 1 wherein the plurality of lines from which the respective segment sets are taken comprise respective parallel lines configured as one of horizontal lines, vertical lines and rotated lines.

6. The method of claim 1 wherein estimating features of the segmented region of interest comprises:
performing a skeletonization operation on the segmented region of interest;
determining a main direction of the segmented region of interest utilizing a result of the skeletonization operation;
performing a scanning operation on the segmented region of interest utilizing the determined main direction to estimate the features.

7. The method of claim 6 wherein performing a scanning operation utilizing the determined main direction comprises:
determining a plurality of lines perpendicular to a line of the main direction; and
scanning the hand region of interest along the perpendicular lines.

8. The method of claim 1 wherein identifying a region of interest comprises generating a binary region of interest mask in which pixels within the region of interest all have a first binary value and pixels outside the region of interest all have a second binary value complementary to the first binary value.

9. The method of claim 8 wherein representing the region of interest as a segmented region of interest comprises converting the binary region of interest mask into the segmented region of interest.

10. The method of claim 1 further comprising:
processing the segmented region of interest to determine connectivity components; and
applying at least one of a dynamic background removal operation, a dot removal operation and a hole removal operation to the segmented region of interest based on the determined connectivity components.

11. The method of claim 1 further comprising:
applying at least one morphological operation to the segmented region of interest; the morphological operation comprising at least one of a dilation operation, an erosion operation, an opening operation and a closing operation;
wherein the dilation operation comprises increasing a length of at least one segment of a given line, adding at least one new segment to each of a plurality of neighboring lines of the given line and uniting any intersecting segments into a single segment;
wherein the erosion operation comprises inverting the segmented region of interest, applying the dilation operation to the inverted segmented region of interest, and inverting the result to obtain the segmented region of interest; and
wherein the opening and closing operations each comprise a distinct sequence of at least one dilation operation and at least one erosion operation.

12. The method of claim 1 wherein estimating features of the segmented region of interest comprises one or more of:
estimating a global width of the segmented region of interest as a difference between a maximal segment end coordinate and a minimal segment begin coordinate over the sets of segments;
estimating a local width of the segmented region of interest for a specified line as a difference between an end coordinate of a final segment of that line and a begin coordinate of an initial segment of that line;
estimating a global height of the segmented region of interest based on pixel coordinates of first and last ones of the plurality of lines;
estimating a weight of the segmented region of interest for a specified line as a sum of segment lengths for the set of segments from that line;
estimating an area of the segmented region of interest as a sum of weights estimated for respective ones of the plurality of lines;
estimating a perimeter of the segmented region of interest utilizing a recursive procedure based on a weight of the segmented region of interest for a specified line; and
estimating at least one of first and second moments of the segmented region of interest.

13. The method of claim 12 wherein estimating at least one of first and second moments of the segmented region of interest comprises:
estimating a first moment for a first coordinate of the segmented region of interest as a function of segment lengths for all of the segments of the segmented region of interest; and
estimating a first moment for a second coordinate of the segmented region of interest as a function of segment weights for all of the segments of the segmented region of interest.

14. The method of claim 13 further comprising estimating second moments for the respective first and second coordinates as a function of the respective first moments estimated for the respective first and second coordinates.

15. A non-transitory computer-readable storage medium having computer program code embodied therein, wherein the computer program code when executed in the image processor causes the image processor to perform the method of claim 1.

16. An apparatus comprising:
an image processor comprising image processing circuitry and an associated memory;
wherein the image processor is configured to implement a gesture recognition system utilizing the image processing circuitry and the memory, the gesture recognition system comprising a static pose recognition module; and
wherein the static pose recognition module is configured to identify a region of interest in at least one image, to represent the region of interest as a segmented region of interest comprising a union of segment sets from respective ones of a plurality of lines, to estimate features of the segmented region of interest, and to recognize a static pose of the segmented region of interest based on the estimated features.

17. The apparatus of claim 16 wherein a given one of the segments in one of the sets corresponding to a particular one of the lines is represented by a pair of segment coordinates comprising a begin coordinate and an end coordinate, and wherein the plurality of lines from which the respective segment sets are taken comprise respective parallel lines configured as one of horizontal lines, vertical lines and rotated lines.

18. The apparatus of claim 16 wherein the static pose recognition module is configured to identify the region of interest by generating a binary region of interest mask in which pixels within the region of interest all have a first binary value and pixels outside the region of interest all have a second binary value complementary to the first binary value, and to represent the region of interest as a segmented region of interest by converting the binary region of interest mask into the segmented region of interest.

19. An integrated circuit comprising the apparatus of claim 16.

20. An image processing system comprising the apparatus of claim 16.
